(19) United States
(12) Patent Application Publication
(10) Pub. No.: US 2026/0146165 A1
(43) Pub. Date: May 28, 2026

(54) METHOD FOR PRODUCING COATING COMPOSITION FOR STEEL SUBSTRATE

(71) Applicant: KING FAHD UNIVERSITY OF PETROLEUM AND MINERALS, Dhahran (SA)

(72) Inventors: A. Madhan KUMAR, Dhahran (SA); Mohamed Abdrabou HUSSEIN, Dhahran (SA)

(73) Assignee: KING FAHD UNIVERSITY OF PETROLEUM AND MINERALS, Dhahran (SA)

(21) Appl. No.: 19/455,927

(22) Filed: Jan. 22, 2026

Related U.S. Application Data
(62) Division of application No. 18/884,538, filed on Sep. 13, 2024.

(51) Int. Cl. C09D 5/08; C08K 3/22; C08K 5/3475; C09D 163/00; C23C 24/08

(52) U.S. Cl. CPC C09D 5/08; C09D 163/00; C23C 24/085; C08K 3/22; C08K 2003/2241; C08K 5/3475; C08K 2201/005

(57) ABSTRACT

A coating composition for carbon steel includes a titanium dioxide hindered amine light stabilizer (TiO₂-HALs) nanocomposite and an epoxy resin. The TiO₂-HALs nanocomposite is present in the coating composition in an amount 1 to 10 wt. % based on the weight of the coating composition. The TiO₂-HALs nanocomposite includes a homogenous distribution of TiO₂ nanoparticles in a HALs matrix. A method of producing the coating includes synthesizing the TiO₂/HALs nanocomposite, mixing the epoxy resin, and the TiO₂/HALs nanocomposite for 6 to 10 h at a temperature of 25 to 75° C.

### BACKGROUND

### Technical Field

The present disclosure is directed to coatings for carbon steel and, more particularly, toward a fusion-bonded epoxy (FBE) coating composition for carbon steel, methods of making coatings and methods of coating substrates and the resultant coated articles.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Industrial structure development and construction has increased rapidly worldwide recently. As such, a large amount of steel is used in the fields of transportation, construction, machinery, energy, ocean development, and the like. Despite its widespread use, corrosion of steel remains a matter of pressing concern. Anti-corrosive protective coatings are considered an economical and effective method to curb corrosion of steel. Present anti-corrosive coatings, however, need improvement in terms of economic feasibility, efficiency, and long-term corrosion protection capability. In particular, a plurality of epoxies has been explored as an alternative to traditional corrosion-resistant paints and lacquers. In addition to corrosion, ultraviolet (UV) rays from the sun have been shown to inflict damage upon the steel surface. Therefore, a need arises for coatings that provide corrosion and wear protection to steel structures and parts.

CN112266702A provides an epoxy glass flake anti-corrosion coating and preparation method thereof, belonging to the technical field of anti-corrosion coating. The anti-corrosion coating comprises two components; a first component, according to weight ratio, comprises 15 to 20 parts of epoxy resin, 5 to 10 parts of silicon resin, 5 to 10 parts of phenolic resin, and 10 to 18 parts of glass flake. Further, pigment 8 to 15 parts, solvent 5 to 10 parts, ultraviolet absorbent 5 to 10 parts, dispersant 0.5 to 1 parts, antifoaming agent 0.5 to 1 parts. A second component comprises 35-45 parts of polyamide by weight and 15 to 25 parts of solvent by weight.

KR2023035338A describes a coating composition comprising a solvent and a binder, including silica, organically modified silica, titanium oxide, aluminum oxide, zirconium oxide, iron oxide, or a combination thereof. The solvent and the binder further include an anti-corrosive agent, whereas the anticorrosive agent comprises an inhibitor pigment, sacrificial pigment, superhydrophobic agent, and combinations thereof.

One object of the present disclosure is to provide a coating composition for carbon steel that may circumvent the above-stated drawbacks of present methods and publications, such as low efficiency, low longevity, and poor environmental performance.

### SUMMARY

In an exemplary embodiment, a coating composition for carbon steel is described. The coating comprises a titanium dioxide hindered amine light stabilizer (TiO₂-HALs) nanocomposite and an epoxy resin. The TiO₂-HALs nanocomposite is present in the coating composition in an amount of 1 percent by weight (wt. %) to 10 wt. % based on the weight of the coating composition and the TiO₂-HALs nanocomposite comprises a homogenous distribution of TiO₂ nanoparticles in a HALs matrix.

In some embodiments, the HALs is selected from the group consisting of 2-(2-hydroxy-5-methylphenyl) benzotriazole, bis(2,2,6,6-tetramethyl-4-piperidyl) sebacate, and methyl 1,2,2,6,6-pentamethyl-4-piperidyl sebacate.

In some embodiments, the coating is in the form of a coating on steel, as such, the coating has an adhesion strength of 10 to 20 megapascal (MPa).

In some embodiments, the TiO₂ is obtained by mixing a composition containing a titanium tetra-alkoxide, an aqueous acid, and an alcohol, then drying. In some embodiments the titanium tetra-alkoxide is titanium isopropoxide.

In some embodiments, the HALs is 2-(2-hydroxy-5-methylphenyl) benzotriazole.

In some embodiments, the epoxy resin is in the form of dry particles having an average particle size of 50 micrometers (μm) to 150 μm.

In some embodiments, the aqueous acid comprises acetic acid.

In some embodiments, the coating further comprises a phenolic hardener.

In some embodiments, the coating composition has a ratio of resin to phenolic hardener of 3:0.1 to 7:2.

In some embodiments, the coating composition has a ratio of resin to phenolic hardener of 5:1.

In some embodiments, the TiO₂-HALs nanocomposite is present in the coating composition in an amount of 5 wt. % based on the weight of the coating composition.

In some embodiments, the TiO₂-HALs nanocomposite has a particle size of 100 nanometers (nm) or less.

In some embodiments, the coating is in the form of a coating on steel, as such the coating has an adhesion strength of 14.50 MPa.

In some embodiments, an adhesion strength of the coating decreases by less than 25% over 30 days.

In some embodiments, the aforementioned coating has an impedance modulus (|Z|) value of at least 10⁷ Ωcm².

In another exemplary embodiment, a method of producing the coating is described. The method comprises synthesizing the TiO₂/HALs nanocomposite, mixing the epoxy resin, and the TiO₂/HALs nanocomposite for 6 to 10 hours (h) at a temperature of 25 degrees Celsius (° C.) to 75° C.

In some embodiments, the epoxy resin and the TiO₂/HALs nanocomposite are mixed for 8 h at a temperature of 50° C.

In yet another exemplary embodiment, a method of coating a steel object to improve ultraviolet (UV) and corrosion resistance is described. The method comprises spraying the coating composition on the steel object to form a coating and curing the coating for 5 minutes (min) to 25 min at 100° C. to 300° C. The coating has a thickness of 90 μm to 110 μm.

In some embodiments, the coating has a thickness of 100 μm.

In some embodiments, the coating is cured for 15 min at 200° C.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart illustrating a method for producing the coating composition, according to certain embodiments.

FIG. 1B is a flowchart illustrating a method of coating a steel object to improve ultraviolet (UV) and corrosion resistance, according to certain embodiments.

FIG. 2A is a scanning electron microscopy (SEM) image of titanium dioxide (TiO₂), according to certain embodiments.

FIG. 2B is a SEM image of 2.5 wt. % nanocomposite of hindered amine light stabilizers (HALs) and TiO₂ (NC1), according to certain embodiments.

FIG. 2C is a SEM image of 5 wt. % HALs/TiO₂ (NC2), according to certain embodiments.

FIG. 2D is a transmission electron microscopy (TEM) image of TiO₂, according to certain embodiments.

FIG. 2E is a TEM image of HALs/TiO₂ (NC2), according to certain embodiments.

FIG. 2F is an optical image depicting selected area electron diffraction (SAED) pattern of HALs/TiO₂ NC2, according to certain embodiments.

FIG. 3A depicts the infra-red (IR) curve of fusion bonded epoxy (FBE) coating, according to certain embodiments.

FIG. 3B shows an attenuated total reflectance-infrared (ATR-IR) spectra of FBE/TiO₂, according to certain embodiments.

FIG. 3C shows ATR-IR spectra of FBE NC1, according to certain embodiments.

FIG. 3D shows ATR-IR spectra of FBE NC2, according to certain embodiments.

FIG. 4 shows adhesion test results of coated carbon steel (CS) specimens before and after 30 days of immersion in 3.5% sodium chloride (NaCl) solution, according to certain embodiments.

FIG. 5A is a Bode plot of coated CS specimens after 1 day of immersion in 3.5% NaCl solution, according to certain embodiments.

FIG. 5B is a Bode plot of coated CS specimens after 30 days of immersion in 3.5% NaCl solution, according to certain embodiments.

FIG. 5C is a Bode plot of experimentally attained EIS curves of coated CS specimens, according to certain embodiments.

FIG. 5D is a Bode plot of experimentally attained EIS curves of coated CS specimens, according to certain embodiments.

FIG. 6 shows partial dependence plots (PDP) of FBE-coated CS specimens after 30 days of immersion in NaCl, according to certain embodiments.

FIG. 7A is a digital image of an FBE-coated CS specimen after 1000 hours (h) of UV irradiance in a weathering chamber, according to certain embodiments.

FIG. 7B is a digital image of an FBE/TiO₂-coated CS specimen after 1000 h of UV irradiance in a weathering chamber, according to certain embodiments.

FIG. 7C is a digital image of an FBE NC1-coated CS specimen after 1000 h of UV irradiance in a weathering chamber, according to certain embodiments.

FIG. 7D is a digital image of an FBE NC2-coated CS specimen after 1000 h of UV irradiance in a weathering chamber, according to certain embodiments.

FIG. 7E is a digital image of a commercial epoxy-coated CS specimen after 1000 h of UV irradiance in a weathering chamber, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a,” “an” and the like generally carry a meaning of “one or more,” unless stated otherwise.

Furthermore, the terms “approximately”, “approximate”, “about,” and similar terms generally refer to ranges that include the identified value within a margin of 20%, 10%, or preferably 5%, and any values therebetween.

The use of the terms “include,” “comprises”, “including,” “have,” “has,” or “having” should be generally understood as open-ended and non-limiting unless specifically stated otherwise.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

As used herein, the term “composite material” refers to an amalgamation of two materials with distinct physical and chemical properties.

As used herein, “nanoparticles (NPs)” are particles having a particle size of 1 nm to 500 nm.

As used herein, the term “epoxy” refers to a three-atom cyclic ether.

As used herein, “epoxy resins” refers to polymers having one or more epoxy-functionality. They are polymerizable or cross-linkable by a ring-opening reaction of the epoxy functionality. Typically, but not exclusively, the polymers contain repeating units derived from monomers having an epoxy-functionality, but epoxy resins can also contain, for example, silicone-based polymers that contain epoxy groups or organic polymer particles coated with or modified with epoxy groups or particles coated with, dispersed in, or modified with epoxy-groups-containing polymers. The epoxy resins may have an average epoxy functionality of at least one, greater than one, or of at least two. Appropriate multifunctional epoxy resins, as an example, include those based on phenol and cresol epoxinovolacs, glycidyl ether adducts of phenolaldehyde, glycidyl ethers of aliphatic diols, diglycidyl ether, diethylene glycol diglycidyl ether, aromatic epoxy resins, triglycidyl dialiphatic ethers, polyglycidyl aliphatic ethers; epoxidized olefins, brominated resins, aromatic glycidylamines, glycidylimidines and heterocyclic amides, glycidyl ethers, fluorinated epoxy resins.

As used herein the term “curing agent” refers to a compound which, when mixed with the epoxy resin, creates a cured or hardened coating by generating cross-links within the polymer. At times, curing agents are referred to as hardeners.

As used herein, “corrosion” refers to the conversion of materials, for instance, metals into more stable forms. There are two main types of corrosion: general or uniform attack corrosion and galvanic corrosion. Typical or uniform corrosion happens, for instance, when the iron is in a humid environment, creating iron oxide and corroding. Galvanic corrosion occurs when two materials with differing bipolar indices or dislocations are in touch with each other or relatively close to one another when an electrolyte is present. The movement of electrons between materials is created by potential differences. In such a system, one material serves as the cathode and is more active (or less noble), while the other material serves as the anode and is less active (or more inert). The cathode corrodes more slowly than the anode, which corrodes rapidly.

As used herein, “fusion-bonded epoxy (FBE)” refers to an epoxy powder resin that includes resin and hardener components in solid form that are unreacted. Heat curing melts the resin and hardener components and permits reaction to form a polymeric chemical resistant dielectric coating.

As used herein, “sol-gel process” refers to a chemical synthesis method for materials, comprising resins, where an oxide network is developed through, for example, polycondensation reactions of a molecular precursor in a liquid. The finished product of a sol-gel synthesis process can be referred to as a “sol-gel material”, a “sol-gel processed material”, a “sol-gel product” or a “sol-gel processed product.”

Aspects of the present disclosure are directed to ultraviolet (UV)-resistant fusion bonded epoxy (FBE) composite coatings (also referred to as coating) for deposition on carbon steel substrate. Carbon steels can be categorized into three groups depending on their carbon content: low carbon steels/mild steels contain up to 0.3% carbon, medium carbon steels contain 0.3-0.6% carbon, and high carbon steels contain more than 0.6% carbon. In a preferred embodiment, the steel is low-carbon steel, more preferably RS-14 low-carbon steel. In some embodiments, the coating composition may also be applied to other steel, such as alloy, stainless, austenitic, ferritic, martensitic, or mixtures thereof.

The coating composition comprises a TiO₂-HALs nanocomposite. The TiO₂-HALs composite comprises TiO₂ nanoparticles and a hindered amine light stabilizer (HALs) matrix. The TiO₂ nanoparticles are homogenously distributed in the HALs matrix. The HALs matrix preferably comprises at least one of 2-(2-hydroxy-5-methylphenyl) benzotriazole, bis(2,2,6,6-tetramethyl-4-piperidyl) sebacate, and methyl 1,2,2,6,6-pentamethyl-4-piperidyl sebacate. In a preferred embodiment, the HALs matrix comprises 2-(2-hydroxy-5-methylphenyl) benzotriazole.

In some embodiments, the TiO₂-HALs nanocomposite is present in the coating composition in an amount of 1 to 10 percent by weight (wt. %), preferably 2 to 9 wt. %, preferably 3 to 8 wt. %, preferably 4 to 7 wt. %, and preferably 5 to 6 wt. % based on the weight of the coating composition. In a preferred embodiment, the TiO₂-HALs nanocomposite is present in the coating composition in an amount of 5 wt. % based on the weight of the coating composition. The TiO₂-HALs nanocomposite has a particle size of 100 nm or less, preferably 90 nm, preferably 85 nm, preferably 80 nm, preferably 75 nm, preferably 70 nm, preferably 65 nm, and preferably 60 nm. In some embodiments, the TiO₂ nanoparticles in the TiO₂-HALs nanocomposite may be spherical or globular with a smooth surface, although other shapes may exist as well. In some embodiments, the nanocomposite particles agglomerate together to form larger spheres or globules. When combined with the FBE, the spherical shape of the nanocomposite becomes more asymmetrical, having a more globular morphology. In an unreacted pre-heating curing form, the FBE is a pulverulent mixture of particles of resin, hardener and TiO₂-HALs nanocomposite. The TiO₂-HALs nanocomposite particles may be dispersed in one or both of the particles of resin and/or hardener or may be present as distinct particles consisting of TiO₂ and HALs.

In some embodiments, the TiO₂-HALs nanocomposite may exist in various morphological shapes, such as nanowires, nanospheres, nanocrystals, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanoflowers, etc., and mixtures thereof.

In some embodiments, the TiO₂-HALs nanocomposite comprise TiO₂ nanoparticles in an amount of 2 to 25 wt. % relative to the total amount of the nanocomposite, preferably 4 to 23 wt. %, preferably 6 to 21 wt. %, preferably 8 to 20 wt %, most preferably 10 to 20 wt. %.

The coating composition further comprises an epoxy resin. Curable epoxy resins comprise monomers, oligomers and/or are polymers having one or more epoxy-functionality. They are polymerizable or cross-linkable by a ring-opening reaction of the epoxy functionality. In some instances, the resultant polymers comprise repeating units derived from monomers having an epoxy-functionality, but epoxy resins can also include, for example, silicone-based polymers that contain epoxy groups or organic polymer particles coated with or modified with epoxy groups or particles coated with, dispersed in, or modified with epoxy-groups-containing polymers. The epoxy resins may have an average epoxy functionality of at least 1, greater than 1, or of at least 2. In some embodiments, the curable epoxy resin composition comprises at least one resin selected from bisphenol A epoxy resin, a bisphenol F epoxy resin, a novolak epoxy resin, an aliphatic epoxy resin, a glycidylamine epoxy resin, an epoxidized vegetable oil, and a mixture thereof. In a preferred embodiment, the epoxy resin comprises bisphenol A flakes. The epoxy resin is in the form of dry particles having an average particle size of 50 to 150 micrometers (μm), preferably 60 to 140 μm, preferably 70 to 130 μm, preferably 80 to 120 μm, preferably 90 to 110 μm.

The coating composition further comprises a phenolic hardener or phenolic curing agents. Suitable examples of phenolic curing agents include hydroxy-functionalized bisphenol F, hydroxy-functionalized novolac-modified bisphenol F, hydroxy-functionalized bisphenol AF, hydroxy-functionalized novolac-modified bisphenol AF, hydroxy-functionalized bisphenol A, hydroxy-functionalized novolac-modified bisphenol A, hydroxy-functionalized phenol and hydroxy-functionalized cresol. Preferred phenolic curing agents include hydroxy-functionalized bisphenol A, hydroxy-functionalized novolac-modified bisphenol A, hydroxy-functionalized phenol, and hydroxy-functionalized cresol. In an embodiment, the phenolic curing agent comprises one or more phenolic hydroxyl groups. In some embodiments, other classes of curing agents that can be used in addition/instead of phenolic curing agents include aromatic amines, carboxylic acids, and carboxylic acid functional resins, guanidines, for example, dicyandiamide, imidazoles, and imidazole (epoxy) adducts, anhydrides, polyamides, dihydrazides and mixtures thereof.

The ratio of resin to phenolic hardener in the coating composition is in the range of 3:0.1 to 7:2, preferably 3.5:0.25 to 6.5:1.75, preferably 4:0.5 to 6:1.5, preferably 4.5:1 to 5.5:1.25, and most preferably of about 5:1 with respect to mass resin to mass hardener.

In some embodiments, the coating has an adhesion strength of 10 to 20 MPa, preferably 11 to 19 MPa, preferably 12 to 18 MPa, preferably 13 to 17 MPa, and preferably 14 to 16 MPa on carbon steel. In a preferred embodiment, the coating has an adhesion strength of 14.50 MPa on carbon steel. In some embodiments, the adhesion strength of the coating decreases by less than 25%, preferably 20%, preferably 15%, preferably 10%, and preferably 5% over 30 days. Adhesion strength may be tested by performing a hydraulic adhesion test in accordance with ASTM D4541 standards. Preferably, the hydraulic adhesion test comprises applying a perpendicular tensile force to a coating and substrate, then applying a pressure until the point that the adhesion fails. The pressure may be achieved using a hydraulic pump. The coating composition has an impedance modulus (|Z|) value of at least 10⁷ Ωcm², preferably 10⁸ Ωcm², and preferably 10⁹ Ωcm². In a preferred embodiment, the coating composition has a |Z| value of 10⁸ Ωcm².

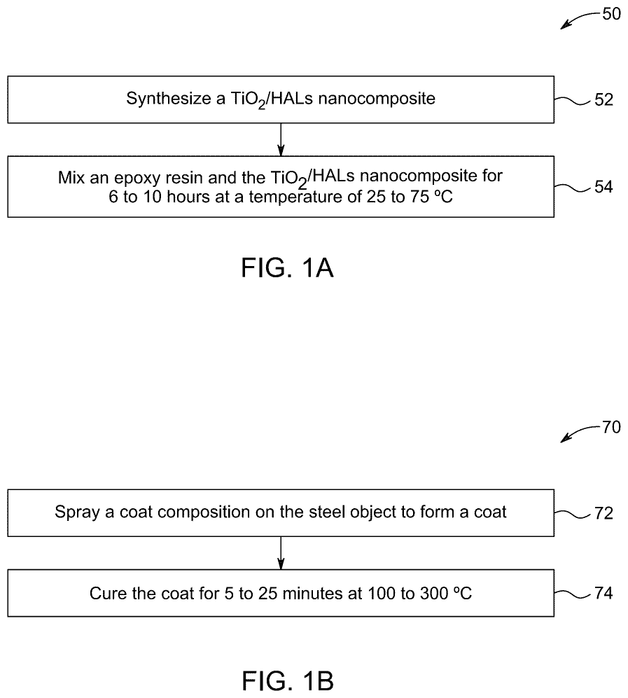

FIG. 1A illustrates a flow chart of method 50 for producing the coating composition. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 comprises synthesizing the TiO₂-HALs nanocomposite. The TiO₂-HALs nanocomposite comprises TiO₂ nanoparticles and a hindered amine light stabilizer (HALs) matrix. The TiO₂ nanoparticles are homogenously distributed in the HALs matrix. Preferably, a major amount of the TiO₂ nanoparticles are completely covered with the HALs and dispersed within the TiO₂-HALs nanocomposite particles. In some embodiments, the TiO₂ nanoparticles are obtained by mixing a composition containing a titanium tetra-alkoxide, an aqueous acid, and an alcohol, then drying. Suitable examples of titanium tetra-alkoxide include titanium methoxide, titanium ethoxide, and titanium isopropoxide. In a preferred embodiment, the titanium tetra-alkoxide is titanium isopropoxide. Suitable examples of aqueous acids include hydrochloric acid (HCl), sulphuric acid (H₂SO₄), phosphoric acid (H₃PO₄), acetic acid (CH₃COOH), hydrofluoric acid (HF), and nitric acid (HNO₃). In a preferred embodiment, the acid is acetic acid. Suitable examples of alcoholic solvents include methanol, ethanol, and isopropanol. In a preferred embodiment, the alcohol is ethanol.

Drying can be done using heating appliances such as hot plates, heating mantles, ovens, microwaves, autoclaves, tapes, oil baths, salt baths, sand baths, air baths, hot-tube furnaces, and hot-air guns. In a preferred embodiment, the drying is done using a hot air oven.

The HALs matrix preferably comprises at least one of 2-(2-hydroxy-5-methylphenyl) benzotriazole, bis(2,2,6,6-tetramethyl-4-piperidyl) sebacate, and methyl 1,2,2,6,6-pentamethyl-4-piperidyl sebacate. In a preferred embodiment, the HALs matrix comprises 2-(2-hydroxy-5-methylphenyl) benzotriazole. In some embodiments, the TiO₂-HALs nanocomposite comprises a homogenous distribution of TiO₂ nanoparticles in a HALs matrix.

At step 54, the method 50 comprises mixing an epoxy resin and the TiO₂/HALs nanocomposite for 6 to 10 h, and preferably 7 to 9 h at a temperature of 25 to 75° C., preferably 30 to 70° C., preferably 35 to 65° C., preferably 40 to 60° C., and preferably 45 to 55° C. The mixing may be carried out manually or with the help of a stirrer. In a preferred embodiment, the epoxy resin and the TiO₂/HALs nanocomposite are mixed for 8 h at a temperature of 50° C.

FIG. 1B illustrates a flow chart of a method 70 of coating a steel object to improve UV and corrosion resistance. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 comprises spraying the coating composition on the steel object to form a coating. In alternate embodiments, the coating composition may be coated on the steel object using one of the techniques like the drop-casting method, spin coating, or dip coating. The thickness of the coating on the steel object is in the range of 90 to 110 μm, preferably 91 to 109 μm, preferably 92 to 108 μm, preferably 93 to 107 μm, preferably 94 to 106 μm, preferably 95 to 105 μm, preferably 96 to 104 μm, preferably 97 to 103 μm, preferably 98 to 102 μm, and preferably 99 to 101 μm. In a preferred embodiment, the thickness of the coating on the steel object is about 100 μm.

At step 74, the method 70 comprises curing the coating for 5 to 25 min, preferably 6 to 24 min, preferably 7 to 23 min, preferably 8 to 22 min, preferably 9 to 21 min, preferably 10-20 min, preferably 11 to 19 min, preferably 12 to 18 min, preferably 13 to 17 min, and preferably 14 to 16 min at 100 to 300° C., preferably 110 to 290° C., preferably 120 to 280° C., preferably 130 to 270° C., preferably 140 to 260° C., preferably 150 to 250° C., preferably 160 to 240° C., preferably 170 to 230° C., preferably 180 to 220° C., and preferably 190 to 210° C. In a preferred embodiment, the coating is cured for 15 min at 200° C.

### EXAMPLES

The following examples demonstrate a coating composition for carbon steel. They are provided solely for illustration and are not to be construed as limitations of the present disclosure, as many variations are possible without departing from the spirit and scope of the present disclosure.

### Example 1: Materials

The RS-14 low carbon steel (CS) panels were obtained from Q-Panel, UK. The CS panels were employed as base specimens, each panel having a dimension of about 10 centimeters (cm)×2.5 cm×1.6 millimeters (mm). Powders of s bisphenol A-based epoxy resin, Razeen SR5097, Jana Chemicals, Saudi Arabia, and hardener phenolic flakes, from the same manufacturer powder were acquired. The epoxy resin and the hardener were further processed to acquire a powder in a ball mill instrument (PULVERISETTE 7 Mill). Agate balls with a diameter of 10 mm were utilized with a 250 revolutions per minute (rpm) rotational rate and a ball-to-powder ratio of 10:1. Following a four-hour ball milling process; the powder particles underwent a sieving procedure to reach an average particle size of about 75 micrometers (μm) to 125 μm.

### Example 2: Synthesis of TiO₂/HALs Nanocomposites

TiO₂ nanoparticles were synthesized using a sol-gel route. 10 milliliters (mL) of titanium isopropoxide, 1 mL of acetic acid, and 50 mL of ethanol were taken together to prepare a precursor solution that was further used to synthesize the nano TiO₂ particles. Further, in order to prepare the nanocomposites, HALs such as 2-(2-hydroxy-5-methylphenyl) benzotriazole were taken in 50 mL of ethanol, and respective quantities of synthesized TiO₂ nanoparticles (10 wt. % and 20 wt. %) were inserted into the solution and stirred well for about 8 hours (h) at the temperature of 50° C. The finished product underwent filtration, washed with ethanol/distilled water, and oven-dried.

### Example 3: Preparation of Fusion Bonded Epoxy (FBE) Coatings on Sol-Gel Coated Steel Specimens

An electrostatic spray gun assembly, Wagner PEM-X1, from the CG lab powder coating unit, was used to apply FBE nanocomposite coatings on CS specimens. A fixed 5:1 ratio was used to determine the portion between resin and hardener. A plurality of parameters, such as output voltage of 90 kilovolts (kV), compressed air pressure of 0.5 megapascals (MPa) to 0.8 MPa, and the distance between the CS and spray gun of 100 mm to 150 mm, were chosen to deposit the suitable FBE coatings by examining their adhesion, thickness, and visible defects. The coating was applied and cured for 15 minutes (min) at 200° C. An elcometer was used to measure the thickness of the developed FBE coatings, and the range of thickness for the prepared coatings was approximately 100±10 μm. FBE coatings without and with the addition of pure TiO₂, 5 wt. %, HALs/TiO₂ nanocomposites, 2.5 wt. % and 5 wt. %, on CS specimens were labeled as FBE, FBE/TiO₂, FBE NC1 and FBE NC2, respectively.

### Example 4: Characterization of FBE Coatings

Attenuated total reflectance-infrared (ATR-IR) spectroscopic measurements with a choice of 400 cm⁻¹ to 4000 cm⁻¹ were used to evaluate the structure of the developed FBE coatings. The surface microstructure of developed nanocomposite materials was examined using scanning electron microscopy (SEM), JEOL JSM-6610 LV, at 20 keV accelerating voltage.

### Example 5: Adhesion Tests on FBE-Coated Steel Specimens

Hydraulic adhesion tests were performed in accordance with ASTM D4541 standard to evaluate the pull-off adhesion strength of the investigated FBE coatings with CS specimens. Initially, a thin layer of the recommended epoxy adhesive was applied on a metal dolly, placed on the coated specimens, and allowed to cure for 24 h. The dolly was then drawn. The degree of adhesion between the FBE and the CS specimen was found to be the maximum force required to remove the FBE coatings from the specimen.

### Example 6: Corrosion Test on FBE-Coated CS Specimens

Using the Gamry Reference 3000 instrument, corrosion tests were conducted electrochemically in a coating test cell assembly. For all electrochemical corrosion tests, an exposure solution containing 3.5% sodium chloride (NaCl) was used. The reference electrode, graphite stick, and exposed CS substrate (1.76 cm²) served as the working, auxiliary, and reference electrodes, respectively. To attain an electrochemically steady state, the open circuit potential (OCP) value was monitored for approximately 1800 s before all electrochemical experiments. On FBE-coated CS substrates, electrochemical impedance spectroscopy (EIS) measurements were conducted at the chosen frequencies of about 100 kilohertz (kHz) to 1 megahertz (MHz) using a 10 mV amplitude and 10 points per decade. The Echem analyst was utilized to perform the EIS simulation procedure and compute the obtained EIS curves. This allowed for the examination of the eminence of the equivalent circuit simulation analyses by monitoring the chi-square (χ²) value. After 30 days of immersion, potentiodynamic polarization tests were performed on the samples under investigation. A potential range of 250 mV versus OCP was selected, and a scanning speed of 1 millivolts per second (mV/s) was used. All corrosion tests were re-iterated at least three times and are reproducible.

### Example 7: UV Resistant Analysis of Coated CS Specimens on UV Atmospheric Chamber

UV-resistant behavior of FBE and FBE nanocomposite coatings on CS specimens was evaluated using the QUV accelerated weathering tester, QUV/Spray Gen 4, UK, for about 1000 h. The test was carried out according to ASTM G154-23 standards. The environmental conditions were set at 8 h of UV irradiation (UVA-340+) and a water spray followed by a 2 h condensation. Temperature and humidity were 60±3° C. and 50±5% RH, respectively.

### Example 8: Surface Analysis

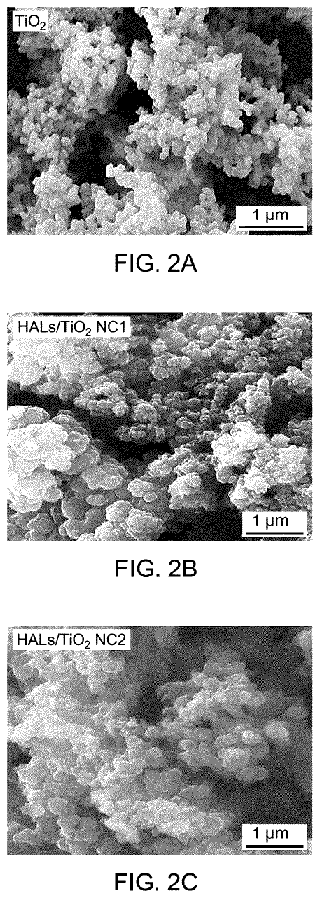

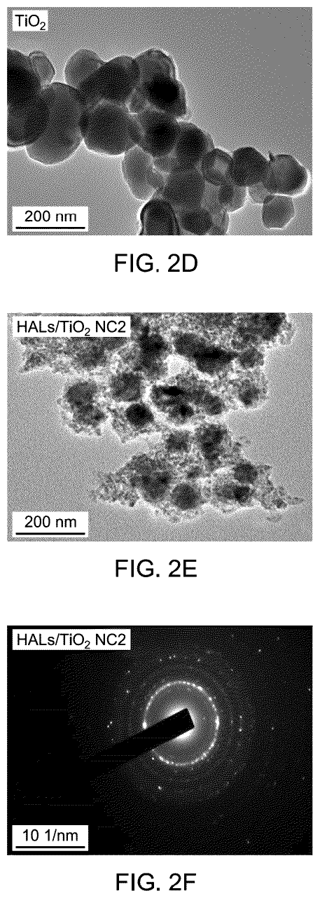

Synthesized TiO₂ and TiO₂ NC samples were inspected using the SEM/EDS observation and the attained results are illustrated in FIGS. 2A to 2C. Pure TiO₂ nanoparticles were spherical with a diameter ranging from 50 nm to 100 nm. In the case of TiO₂ NC samples, it exhibited an asymmetrical globular shape with an increased diameter of about 150 nm to 200 nm. To get complete evidence about the dimension and distribution of TiO₂ particles in the HALs composite matrix, TEM analysis was performed, and the obtained images are illustrated in FIGS. 2D-2E. TEM image of pure TiO₂ particles showed a globular-like morphology with a diameter of about 100 nm, as shown in FIG. 2D. The synthesized HALs/TiO₂ nanocomposites displayed spherical morphology with a particle size between 50 nm and 100 nm, as shown in FIG. 2E. TEM image of nanocomposite samples confirms the homogeneous distribution of nano TiO₂ particles into the HALs matrix with minor agglomeration.

### Example 9: Structural Analysis

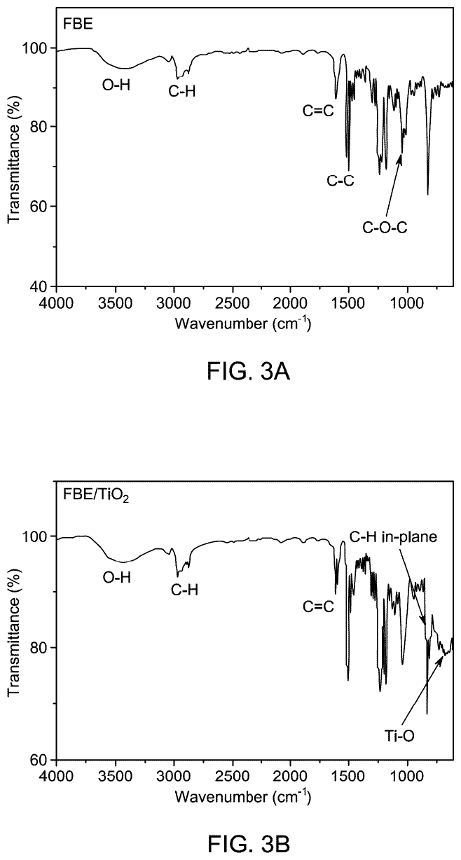

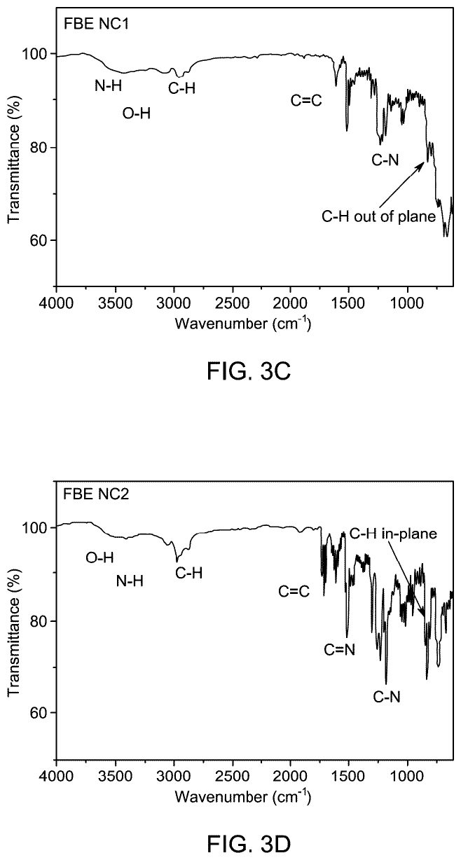

In the case of FBE coatings, the IR peaks at 851 cm⁻¹ and 925 cm⁻¹ were respectively accompanied by the stretching vibrations in C—O—C and C—O of oxirane moieties, as depicted via a graph in FIG. 3A. The two IR bands around 1040 cm⁻¹ and 1245 cm⁻¹ have respectively ascribed with the aliphatic and aromatic ethers of stretching vibrations. The observed peaks at 3610 and 2990 cm⁻¹ were related to the O—H group from the epoxy coating and C—H tension of the methylene group, respectively. FBE/TiO₂ coatings showed the stretching peak of Ti—O at 665 cm⁻¹ related to nano TiO₂, confirming its presence inside the FBE matrix, as shown in FIG. 2B.

On the other hand, HALs/TiO₂ incorporated FBE coatings exhibited both IR peaks from FBE moieties as well the organic components such as HALs of nanocomposite materials, confirming the formation of FBE nanocomposite coatings. Further, more details regarding IR peaks are listed in Table 1.

TABLE 1
IR peaks of FBE, TiO₂, and HALs moieties.

| Peaks (cm⁻¹) | Functional groups |
|---|---|
| 3590 | O—H stretching of alcohols |
| 2985 | C—H stretching of methylene |
| 1608 | C═C stretching of aromatic rings |
| 1505 | C—C stretching of phenylene |
| 1255 | C—O—C stretching of aromatic ethers |
| 1183 | C—C stretching of phenyl group |
| 1109 | C—C stretching of aliphatic chain |
| 1055 | C—O—C stretching of aliphatic ethers |
| 912 | C—O stretching of oxirane group |
| 845 | C—O—C stretching of oxirane group |
| 665 | Ti—O stretching of nanoTiO₂ |

### Example 10: Adhesion Test

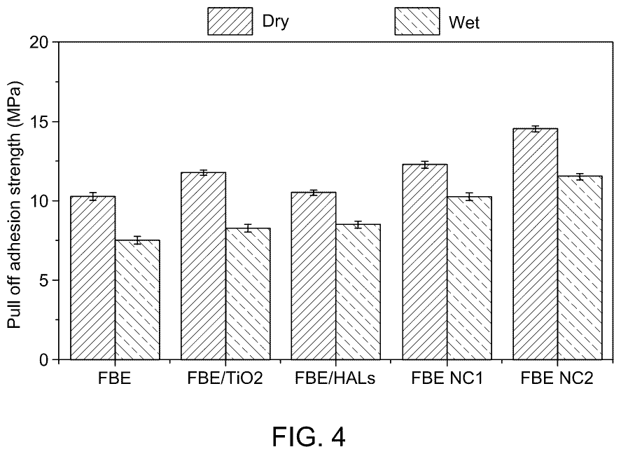

The adhesion strength between developed FBE coatings and CS specimens was evaluated using the pull-off adhesion tester, and the obtained findings are illustrated in FIG. 4. The adhesion strength of pure FBE-coated CS specimen is found to be around 10.25 MPa. After incorporating the prepared HALs/TiO₂ nanocomposites, the adhesion strength of the FBE coating is gradually raised to around 14.50 MPa, validating the improved adhesion towards to CS specimen. This enhancement of the adhesion behavior is possibly accompanied by the uniform distribution of HALs/TiO₂ nanocomposite inside the FBE matrix and increasing the bonding ability of FBE towards the CS surface. After 30 days of corrosion test, the adhesion strength of both pure FBE and FBE nanocomposite-coated CS specimens was significantly reduced, validating the lower adhesion strength due to the corrosion damages occurring at the interface of FBE/CS. However, FBE nanocomposite-coated CS specimens exhibited a higher adhesion strength of 11.5 MPa, which is higher than the FBE-coated CS, corroborating the less corrosion taking place at their interface.

### Example 11: Corrosion Protection Performance

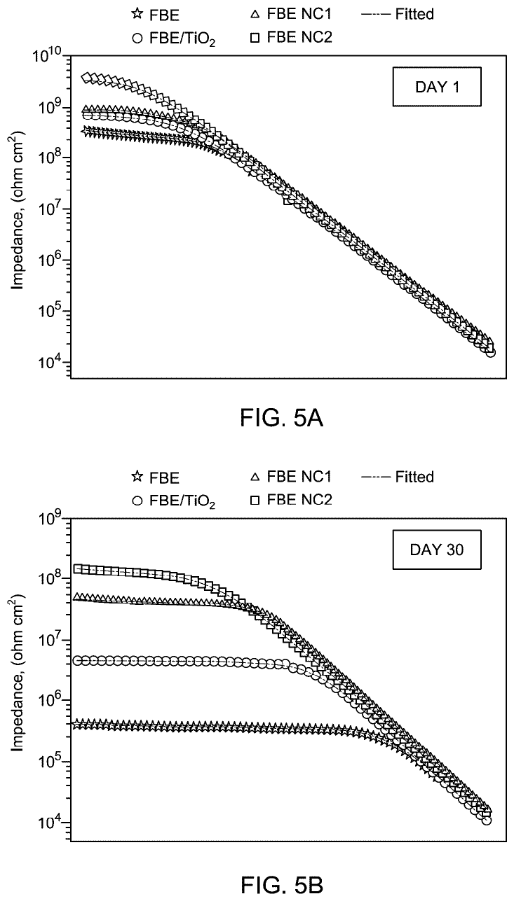

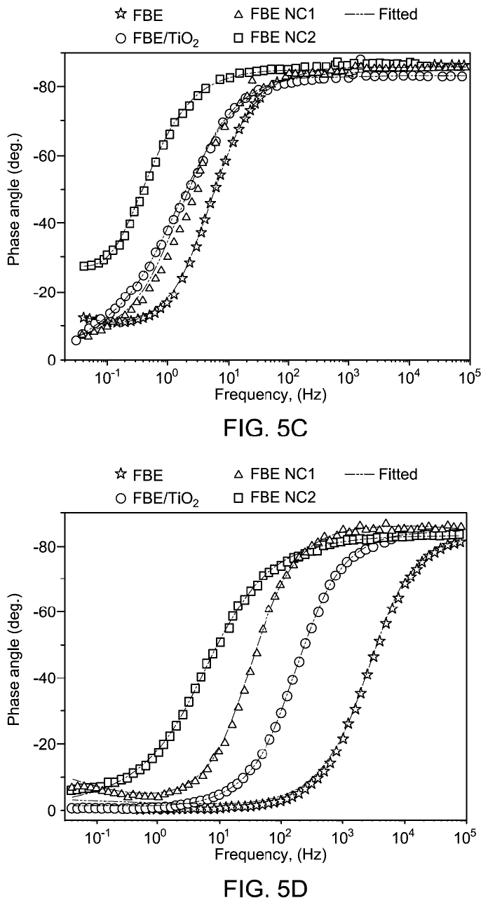

The experimentally attained EIS curves of coated CS specimens are displayed in FIG. 5A-FIG. 5D, in Bode format. All the coated CS specimens displayed a two-time constant behavior in the examining frequencies. The time constant concerning high frequencies is accompanied by the responses of the electrolytic/film interface, whereas the low-frequency time constant is related to the corrosion process arising at the metal/electrolytic interface. In general, the impedance modulus (|Z|) value was contrariwise proportional to the rate of the corrosion. The |Z| of the FBE coating CS specimens was observed to be about 10⁵ Ωcm² to 10⁶ Ωcm², whereas FBE coatings with HALs/TiO₂ nanocomposites showed around 10⁸ Ωcm² after 30 days of exposure, which indicates that the coating on CS specimen is dense and securely bonded. Furthermore, the impedance at 1 Hz indicated the surface protection provided by the FBE composite coatings against corrosion in NaCl, which appeared to raise in the sequence of pure FBE, FBE/TiO₂, FBE/HALs/TiO₂ nanocomposites presenting a prominently enhanced impedance when compared to that of bare substrate.

To quantitatively evaluate the electrochemical corrosion process taking place at coated CS specimens, the obtained EIS curves are fitted to the relevant equivalent circuit model in FIG. 5A, FIG. 5B, FIG. 5C, and FIG. 5D, which is the model utilized for coated metallic substrates. In this model, Rₛ, R_{f}, R_{ct}, signify solution resistance, coating resistance, and charge transfer resistance, respectively. Further, CPE_{f}, and CPE_{dl} denote the constant phase element (CPE) of the film and double layer, respectively. The capacitor (C) was replaced with the CPE to obtain an appropriate EIS circuit fit because the resulting non-ideal behavior of the response with phase shifts other than 90° was observed. The metallic samples with protective coatings having an enhanced corrosion resistance usually show lower values of CPE_{f} and CPE_{dl} and higher values of R_{f} and R_{ct}. Therefore, for the FBE/HALs/TiO₂ nanocomposite coated CS, higher R_{ct} and R_{f} values and lower CPE_{f} and CPE_{dl} values designate the improved physical barrier characteristics of the FBE coatings after 30 days in immersion in NaCl medium. FBE coatings with the reinforcement of 5 wt. % HALS/TiO₂ displayed higher surface protective characteristics on CS specimens after the immersion of 30 days in NaCl medium.

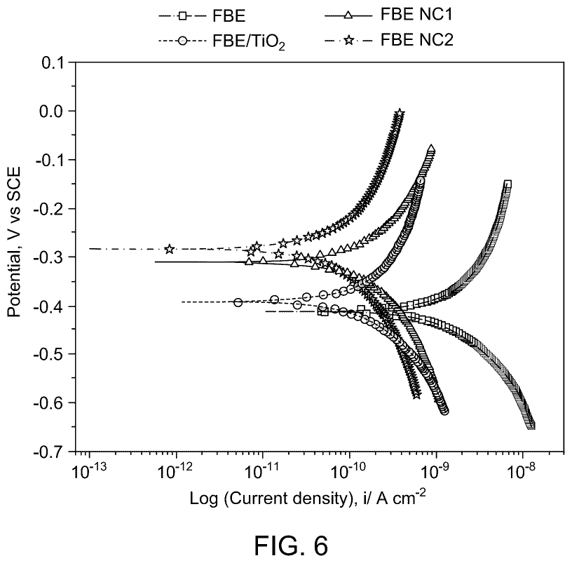

FIG. 6 depicts the representative PDP plots for coated CS specimens after the exposure of 30 days in NaCl. In general, anodic regions are associated with the corrosion process of the coating metallic substrates, while cathodic sites are linked to the evolution of hydrogen. Further, a less i_{corr} and positive E_{corr} represented the improvement in the anticorrosion performance in NaCl medium. In comparison with the pure FBE-coated specimens, the current densities of the FBE coatings with the inclusion of nanocomposites were reduced by one order of magnitude. The FBE/5HALs/TiO₂ coating with an E_{corr} and a lower cathodic current density is inferred to have the highest surface protective performance among the inspected coated carbon steel specimens. It is revealed that the surface protective behavior of FBE coatings is significantly improved after the addition of HALs/TiO₂ nanocomposites into the FBE matrix.

### Example 12: UV-Resistant Performance

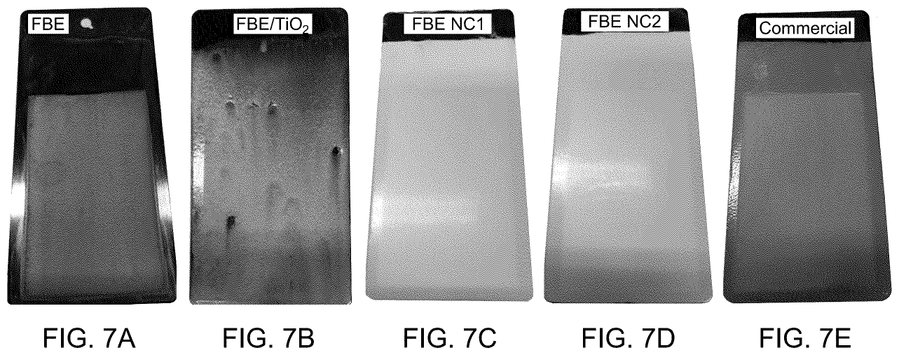

The photo digital images of the coated CS specimens after 1000 h of exposure in an artificial weathering chamber are shown in FIG. 7A to FIG. 7E. FIG. 7A to FIG. 7E are digital images after 1000 h of UV irradiance in a weathering chamber of FBE-coated CS, FBE/TiO₂, FBE NC1, FBE NC2, and commercial epoxy-coated CS specimen. respectively. FBE-coated CS specimens exhibit surface discoloration after exposure to 1000 h, where FBE coating became yellowish on their surface. This observation occurred because of the interaction between the epoxy molecules and the photons of UV radiation on the exposed surface causing photo-oxidative reactions. Even though the color variations were visible in FBE and FBE/TiO₂ samples, fading was not very noticeable for FBE nanocomposite-coated CS specimens. From the obtained findings, it may be concluded that the reinforcement of HALs/TiO₂ nanocomposites into FBE may increase the UV-resistant properties of the FBE coatings.

To summarize, the aspects of the present disclosure provide a coating composition for carbon steel and a method of preparation thereof. Further, the present disclosure also provides a method of application of the coating composition. The UV-resistant FBE composite coatings include reinforcing the hybrid UV-resistant nanocomposites based on the TiO₂ nanoparticles and HALs. The performance measurements of the deposited composited coating showed improved UV resistant performance after the continuous irradiance of UV light for about 1000 h and improved the anticorrosive activity of FBE coatings on steel panels in NaCl medium. The UV-resistant behavior of FBE-coated steel specimens was evaluated using the weathering chamber, and the obtained results validated the improved UV-resistant performance of developed FBE nanocomposite coating after the continuous irradiance of UV light for about 1000 h. The disclosed coating composition may provide dual protection as it is based on UV absorbers and HALs-reinforced FBE films with improved UV and corrosion protection, and enhanced interfacial adhesion strength.

Numerous modifications and variations of the present disclosure are possible in light of the above teachings. It is therefore to be understood that within the scope of the appended claims, the invention may be practiced otherwise than as specifically described herein.

1. (canceled)

2. The method of claim 16, wherein the TiO₂-HALs nanocomposite comprises a HALs selected from the group consisting of 2-(2-hydroxy-5-methylphenyl) benzotriazole, bis(2,2,6,6-tetramethyl-4-piperidyl) sebacate, and methyl 1,2,2,6,6-pentamethyl-4-piperidyl sebacate.

3. The method of claim 16, further comprising:
applying the coating composition on a steel substrate to form a coating having an adhesion strength of 10 to 20 MPa.

4. The method of claim 16, further comprising:
forming the TiO₂ of the TiO₂-HALs nanocomposite by mixing a composition containing a titanium tetra-alkoxide, an aqueous acid and an alcohol, then drying, wherein the titanium tetra-alkoxide is titanium isopropoxide.

5. The method of claim 16, wherein the HALs of the TiO₂-HALs nanocomposite is 2-(2-Hydroxy-5-methylphenyl) benzotriazole.

6. The method of claim 16, wherein the epoxy resin is in the form of dry particles having an average particle size of 50 to 150 μm.

7. The method of claim 4, wherein the aqueous acid comprises acetic acid.

8. The method of claim 16, further comprising:
mixing a phenolic hardener with the coating composition, and
curing to form a cured coating.

9. The method of claim 8, wherein the coating composition has a ratio of resin to phenolic hardener of 3:0.1 to 7:2.

10. The method of claim 8, wherein the coating composition has a ratio of resin to phenolic hardener of 5:1.

11. The method of claim 16, wherein the TiO₂-HALs nanocomposite is present in the coating composition in an amount of 5 wt. % based on the weight of the coating composition.

12. The method of claim 16, wherein the TiO₂-HALs nanocomposite has a particle size of 100 nm or less.

13. The method of claim 16, further comprising:
applying the coating composition onto a steel substrate, and then
curing the coating composition to form a cured coating having an adhesion strength of 14.50 MPa.

14. The method of claim 13, wherein an adhesion strength of the coating decreases by less than 25% over 30 days.

15. The method of claim 13, wherein the cured coating has an impedance modulus (|Z|) value of at least 10⁷ Ωcm².

16. A method of producing a coating composition, comprising:
synthesizing a TiO₂-HALs nanocomposite; and
mixing an epoxy resin and the TiO₂-HALs nanocomposite for 6 to 10 h at a temperature of 25 to 75° C. to form the coating composition;
wherein the TiO₂-HALs nanocomposite is present in the coating composition in an amount of 1 to 10 wt. % based on the weight of the coating composition, and
wherein the TiO₂-HALs nanocomposite comprises a homogenous distribution of TiO₂ nanoparticles in a HALs matrix.

17. The method of claim 16, wherein the epoxy resin and the TiO₂/HALs nanocomposite are mixed for 8 h at a temperature of 50° C.

18-20. (canceled)
